(19) United States
(12) Patent Application Publication
(10) Pub. No.: US 2025/0110285 A1
(43) Pub. Date: Apr. 3, 2025

(54) ARCHITECTURES AND METHODS FOR ATTACHING PHOTONIC INTEGRATED CIRCUITS (PICs) TO OPTICAL CONNECTORS

(71) Applicant: Intel Corporation, Santa Clara, CA (US)

(72) Inventors: Sufi R. Ahmed, Chandler, AZ (US); Darren Vance, Gilbert, AZ (US); Sang Yup Kim, Sunnyvale, CA (US); Anthony Traynor, Livingston (GB); Eric J. M. Moret, Beaverton, OR (US)

(73) Assignee: Intel Corporation, Santa Clara, CA (US)

(21) Appl. No.: 18/478,607

(22) Filed: Sep. 29, 2023

(51) Int. Cl. G02B 6/36

(52) U.S. Cl. CPC G02B 6/3652

(57) ABSTRACT

Architectures and methods for attaching photonic integrated circuits (PICs) to optical connectors. The architectures are characterized by (1) a cavity at a specific location with respect to a trench alongside an optical facet of the PIC die, (2) index matching epoxy (IME) in the trench and in the cavity, and (3) the use of a snap cure adhesive between the PIC and the optical connector.

### BACKGROUND

Many multi-die assemblies require a silicon photonic integrated circuit (PIC) to be optically connected to an optical connector component. In support of this, various architectures and methodologies have been developed to assure alignment efficiency and security of the attachment between the components. However, continued improvements to attachment architectures and methods are desired.

### BRIEF DESCRIPTION OF THE DRAWINGS

FIG. 1 is a simplified top-down view of an exemplary system including a photonic integrated circuit (PIC) die attached to an optical connector component, in accordance with various embodiments.

FIG. 2A is a simplified top-down view of a connector architecture as may be implemented in the optical connector component, in accordance with various embodiments.

FIG. 2B is a simplified top-down view of a connector architecture as may be implemented in the PIC die, in accordance with various embodiments.

FIGS. 3A, 3B, 3C, 4A, and 4B are simplified top-down views showing a process for implementing an embodiment of the connector architecture implemented in the optical coupler, in accordance with various embodiments.

FIGS. 5A, 5B, 5C, 6A, and 6B are simplified top-down views showing a process for implementing an embodiment of the connector architecture implemented in the PIC die, in accordance with various embodiments.

FIG. 7 is an exemplary method for making a system with the PIC die attached to the optical connector component using an embodiment of the connector architecture, in accordance with various embodiments.

FIG. 8 is a top view of a wafer and dies that may be included in a microelectronic assembly, in accordance with any of the embodiments disclosed herein.

FIG. 9 is a simplified cross-sectional side view showing an implementation of an integrated circuit on a die that may be included in various embodiments, in accordance with any of the embodiments disclosed herein.

FIG. 10 is a cross-sectional side view of a microelectronic assembly that may include any of the embodiments disclosed herein.

FIG. 11 is a block diagram of an example electrical device that may include any of the embodiments disclosed herein.

### DETAILED DESCRIPTION

The following detailed description is merely exemplary in nature and is not intended to limit the application and uses. It may be evident that the novel embodiments can be practiced without every detail described herein. For the sake of brevity, well known structures and devices may be shown in block diagram form to facilitate a description thereof.

In various optical modules and multi-die assemblies, a silicon photonic integrated circuit (PIC) may be optically attached/coupled to an optical connector component. Optical connector components can include glass waveguide substrates and fiber array units (FAUs). Ensuring a robust interface (i.e., optimized attachment and optical alignment) between the PIC and the optical connector component is a technical problem to solve.

Some solutions to this technical problem utilize a lithography process on respective components to create a precision v-groove feature that can be mated together along an optical waveguide facet (shortened herein to optical facet). This passive alignment technique can result in a hard gap in the optical path between the optical coupling component and a trench in the PIC die that is in front of the optical facet leading into waveguides of the PIC die. Often, after mating the v-grooves together, an index matching epoxy (IME) is dispensed in one or more seams between components.

However, the dimensions of the hard gap are small and continue to be reduced as the technology roadmap proceeds. For example, in many designs, that hard gap is about 20 microns, and some technology roadmaps predict it will be less than or equal to 10 microns in the near future. As the gap gets smaller, dispensing the IME into it can be more difficult and this can lead to an undesirable overflow on the waveguides.

The present disclosure provides a technical solution to the above-described problems related to attaching an optical coupling component to a PIC die and provides an improvement over the limitations of available solutions, in the form of architectures and methods for attaching photonic integrated circuits (PICs) to optical connectors. Aspects of the disclosure are characterized by (1) a cavity at a specific location with respect to a trench alongside an optical facet of the PIC die, (2) index matching epoxy (IME) in the trench and in the cavity, and (3) the use of a snap cure adhesive between the PIC and the optical connector. The architectures and methods for attaching photonic integrated circuits (PICs) to optical connectors are described in more detail in connection with the figures below.

Embodiments can significantly improve the throughput time (TPT) per wafer; in some scenarios, the TPT improvement was 3 times faster than without the methodology and architecture. Additionally, embodiments maintain accuracy, yield/cost, reliability, and in-use strength of the optical connector, which is one of the most technically challenging aspects of optical module or multi-die assembly.

Example embodiments are hereinafter described in conjunction with the following drawing figures, wherein like numerals denote like elements. Figures are not necessarily to scale but may be relied on for spatial orientation and relative positioning of features. As may be appreciated, certain terminology, such as “ceiling” and “floor”, as well as “upper,”, “uppermost”, “lower,” “above,” “below,” “bottom,” and “top” refer to directions based on viewing the Figures to which reference is made. Further, terms such as “front,” “back,” “rear,”, “side”, “vertical”, and “horizontal” may describe the orientation and/or location of portions of the component within a consistent but arbitrary frame of reference which is made clear by reference to the text and the associated Figures describing the component under discussion. Such terminology may include the words specifically mentioned above, derivatives thereof, and words of similar import.

As used herein, the term “adjacent” refers to layers or components that are in direct physical contact with each other, with no layers or components in between them. For example, a layer X that is adjacent to a layer Y refers to a layer that is in direct physical contact with layer Y. In contrast, as used herein, the phrase(s) “located on” (in the alternative, “located under,” “located above/over,” or “located next to,” in the context of a first layer or component located on a second layer or component) includes (i) configurations in which the first layer or component is directly physically attached to the second layer (i.e., adjacent), and (ii) component and configurations in which the first layer or component is attached (e.g. coupled) to the second layer or component via one or more intervening layers or components.

The term “overlaid” (past participle of “overlay”) may be used to refer to a layer to describe a location and orientation for the layer but does not imply a method for achieving the location and orientation. For example, a first layer overlaid on a second layer, or overlaid on a component means that the first layer is spread across or superimposed on the second layer or component. Accordingly, a layer that is overlaid on a second layer may be viewed in a cross-sectional view as adjacent to the second layer.

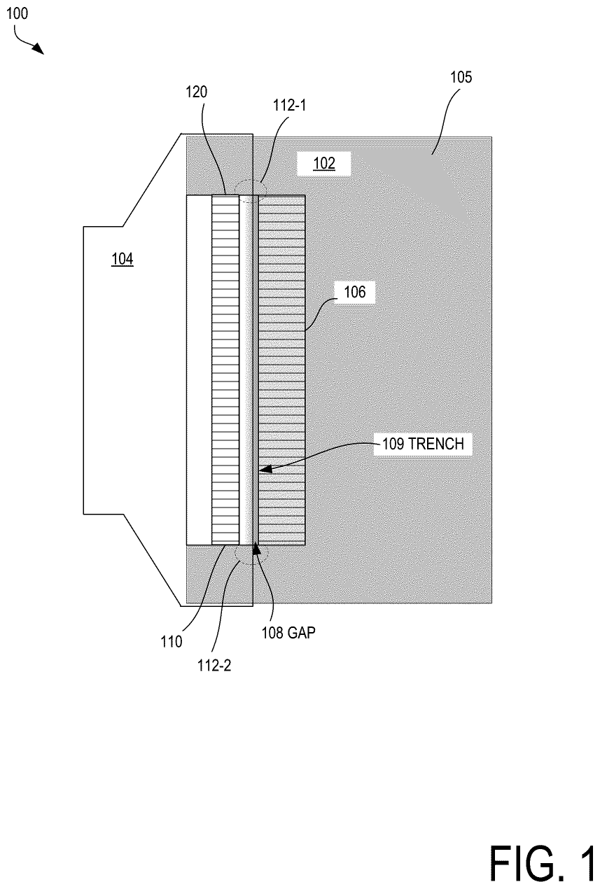

FIG. 1 is a simplified view of an exemplary apparatus or system 100 including a photonic integrated circuit (PIC) die attached to an optical connector 104 component using the herein described connector architecture 112-1, 112-2. The connector architecture 112-1 and 112-2 is characterized by a cavity with index matching epoxy (IME) therein. As is described in more detail below, in various embodiments, the cavity can be in the PIC die or in the optical connector component. Further, the IME of the cavity can be that which is in the optical path, in a trench located by an optical facet. In various applications, the trench is also referred to as an edge cavity formed in the semiconductor substrate of the PIC die. These concepts are developed below.

A photonic integrated circuit (PIC) in a semiconductor substrate 105 is indicated as PIC 102 die. The PIC 102 die may comprise a silicon substrate layer or core of about 250-750 microns thick (wherein “about” means plus or minus 10%). As may be appreciated, the PIC 102 die includes a miniaturized circuit that integrates various electric and photonic components, such as lasers, modulators, detectors, and waveguides. The PIC 102 die includes one or more optical channels or waveguides 106. The waveguides 106 may comprise silicon nitride and may be encased in a transparent dielectric material or cladding layer comprising oxygen and may include silicon dioxide.

The waveguides 106 may be routed differently around the silicon substrate and then collectively terminate at an optical facet. The optical facet is where the waveguides of the PIC 102 die are exposed, to couple them to external optical components, such as the optical connector 104 component. The optical facet may have alongside it a trench 109 (also sometimes referred to as an edge cavity, or depressed surface area) as illustrated.

The optical connector 104 component is understood to include multiple glass waveguides to optically couple to the waveguides 106 in the PIC 102 die. The optical connector 104 component may comprise glass. As used herein, “glass” can be an alkali-free alkaline earth boro-aluminosicilate glass, such as a glass comprising aluminum, oxygen, boron, silicon, and an alkaline-earth metal (e.g., beryllium, magnesium, calcium, strontium, barium, radium, such as a glass comprising SiO2, Al2O3, B2O3, and MgO), or a photosensitive glass (photomachineable or photostructurable glass). In some embodiments, a photosensitive glass can be a glass that belongs to the lithium-silicate family of glass (e.g., a glass comprising lithium, silicon, and oxygen) comprising metallic particles, such as gold, silver, or other suitable metallic particles.

As may be appreciated, respective PIC dies may include regions reserved for electrical connections, such as solder balls solder bumps, or the like. In addition to the optical waveguides 106 there can be metal routing layers around/on/through the PIC 102 die.

The PIC 102 die may also have a band of v-grooves 110, etched into the semiconductor substrate 105 to assist in aligning the optical connector 104 component thereto. The optical connector 104 component is understood to include a matching row/band of v-grooves 120 that mate with v-grooves 110, as indicated in the figure, for a passive or kinematic alignment. In a kinematic coupling, the two components are designed with matching geometry that interlocks precisely when brought together. When the optical connector 104 component is attached to the PIC 102 die, the v-grooves 110 are interleaved with the v-grooves 120. This interlocking mechanism (embodied as the v-grooves on each component) allows the components to be joined with high accuracy and repeatability.

The aforementioned hard gap 108 in the optical path between the optical connector 104 component and the optical facet in the PIC 102 die (indicated with the arrow) can be observed when the two components are attached; the hard gap 108 extends from the first end of the optical facet of the waveguides 106 to a second end, substantially colinear with an edge of the optical connector 104 component, also substantially colinear with the trench 109.

In various embodiments described herein, the trench (e.g., an edge cavity) at gap 108 is filled with an IME as part of completing the coupling of the optical connector 104 component to the PIC 102 die. As those with skill in the art will appreciate, the IME is a liquid or gel selected to have an index of refraction that closely matches a glass reflective index so that light can travel straight through from the PIC 102 waveguides 106 to waveguides in the optical connector 104 component (eliminating the effect of air and a corresponding air refractive index).

Notable in FIG. 1 is that there are two connector architectures 112-1 and 112-2; one is positioned at the first end of the trench 109 and a second is positioned at the second end of the trench 109. The connector architecture 112-1/112-2is characterized by a cavity formed near the trench 109 and wherein the IME from the trench 109 is in fluid communication with the cavity. Depending on the embodiment, the cavity may be formed in the surface of the PIC die or alternatively it may be formed in the optical connector component. In the following figures, the details of these connector architectures are developed.

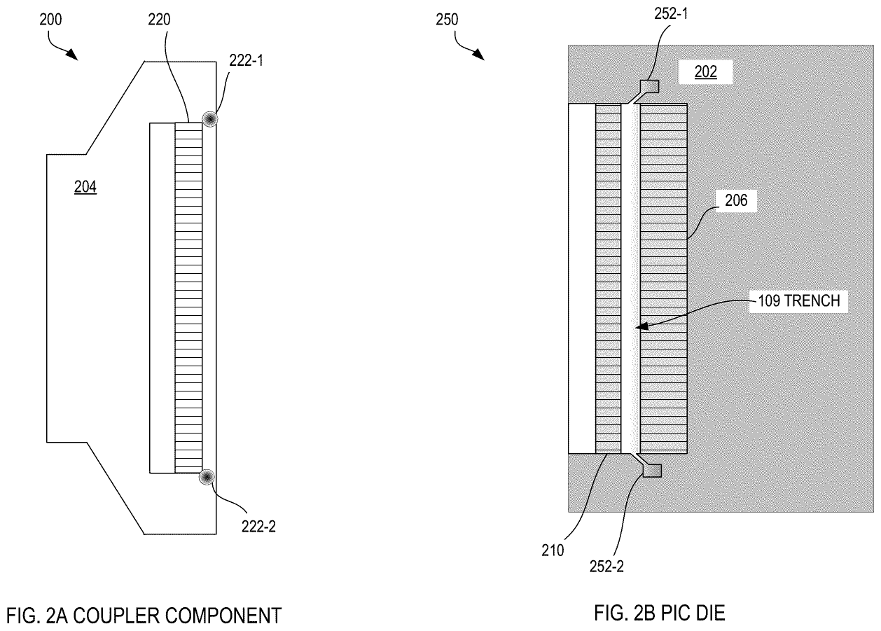

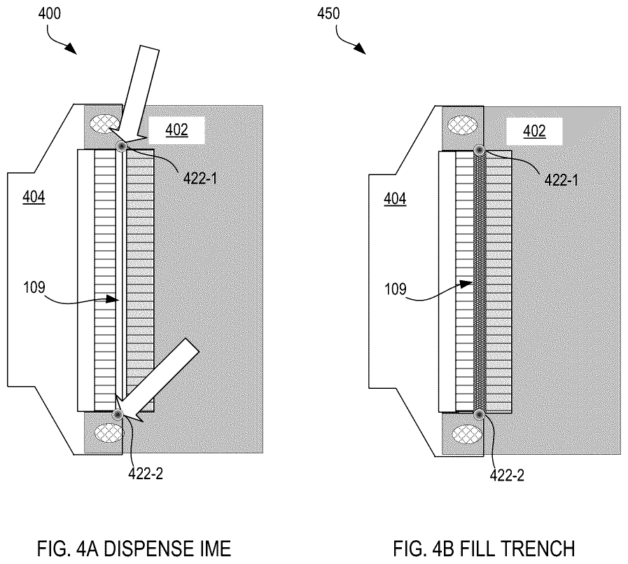

In FIG. 2A, an option is depicted in which the connector architecture 222-1 and connector architecture 222-2 are implemented in the optical connector 104/204 component. In this variation, the connector architecture 222-1 and the connector architecture 222-2 are implemented as a through glass via (TGV) extending completely through the body of the coupler component 204, such that, when it is attached to the PIC 102 die, a first TGV 222-1 provides a fluid path from the trench 109 to the external surface of the optical connector 104/204 component and the second TGV 222-2 provides a fluid path from the trench to the external surface of the optical connector 104/204 component, also as shown. In various embodiments, the TGV's are located such that, when the optical connector 104/204 component is attached to the PIC 102 die, the first TGV 222-1 is at the first end of the trench 109 and the second TGV 222-2 is at the second end of the trench 109, as shown in FIGS. 4A-4B (regardless of the number of waveguides 106/206 in the design).

FIG. 2B illustrates an option with the connector architecture implemented on the PIC 102 die. FIG. 2B is a simplified top-down view showing connector architecture 252-1 and connector architecture 252-2, in accordance with various embodiments. Although the figure is not to scale, it is intentional to depict that one connector architecture 252-1 is at a first end of the trench 109 and a second connector architecture 252-2 is at the second end of the trench 109, as shown (i.e., regardless of the number of waveguides in the design). In FIG. 2B, the respective connector architectures 252-1, 252-2 may take the form of a cavity in the silicon substrate at respective ends of the trench. The specific shape of the cavity is variable. In various embodiments, the cavity can further be characterized as having a capillary channel leading into a reservoir. In various aspects of the invention, the channel portion of the cavity will provide capillary underflow from the trench 109 into the reservoir, when the trench is filled with IME.

The cavities (e.g., channels and reservoirs 252-1/252-2) can be created in a crystalline silicon substrate (having the PIC die therein) at the predetermined locations using lithography and crystallographic etching techniques. In various embodiments, the channels and reservoirs 252-1/252-2 are made using chemicals such as tetramethylammonium hydroxide (TMAH), potassium hydroxide (KOH), or EDP. This process allows the formation of accurate and precise crystallographic (111) planes or facets with about a 54.7-degree angle from a horizontal plane, thereby forming a cavity shaped like a pyramidal pit.

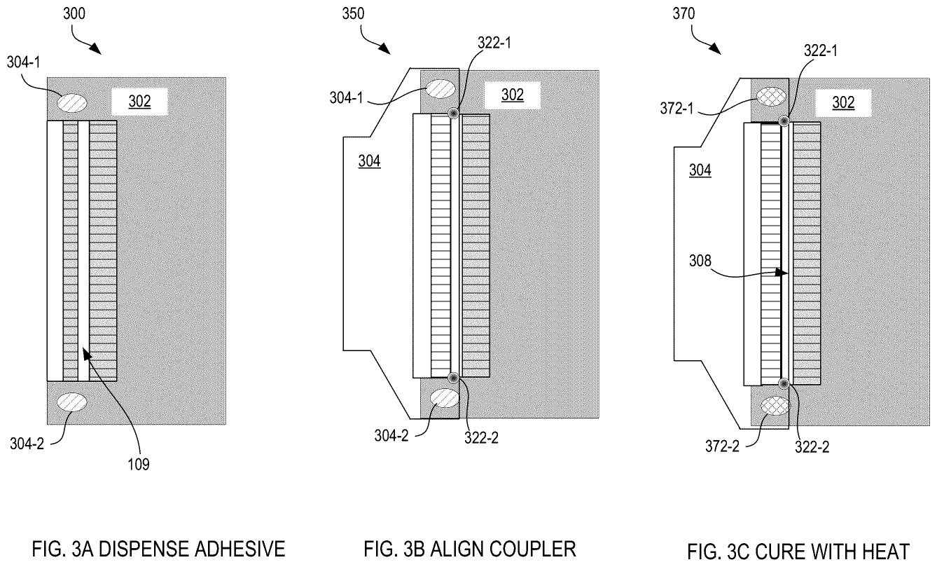

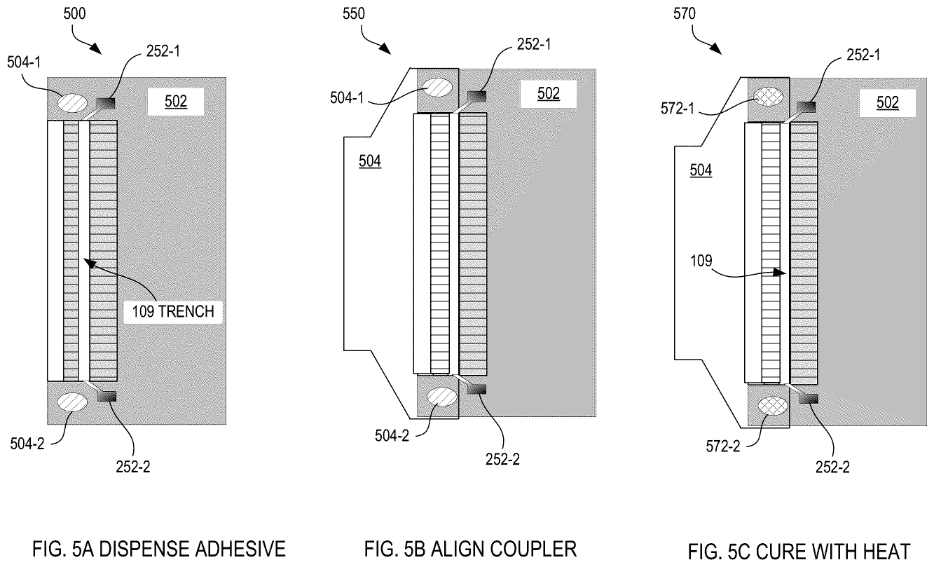

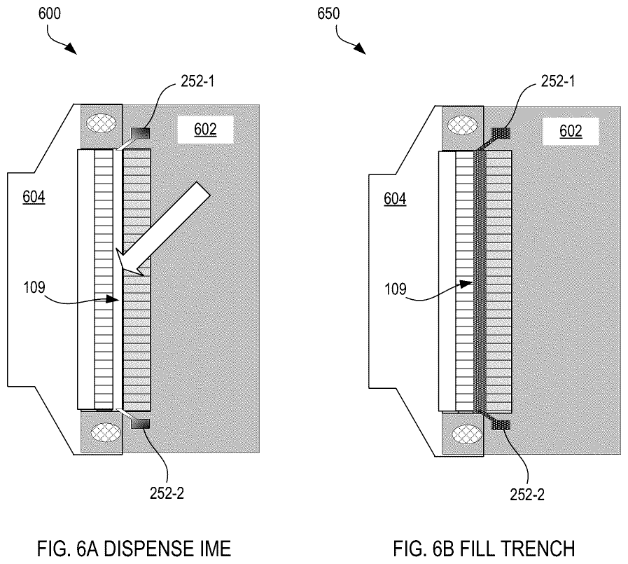

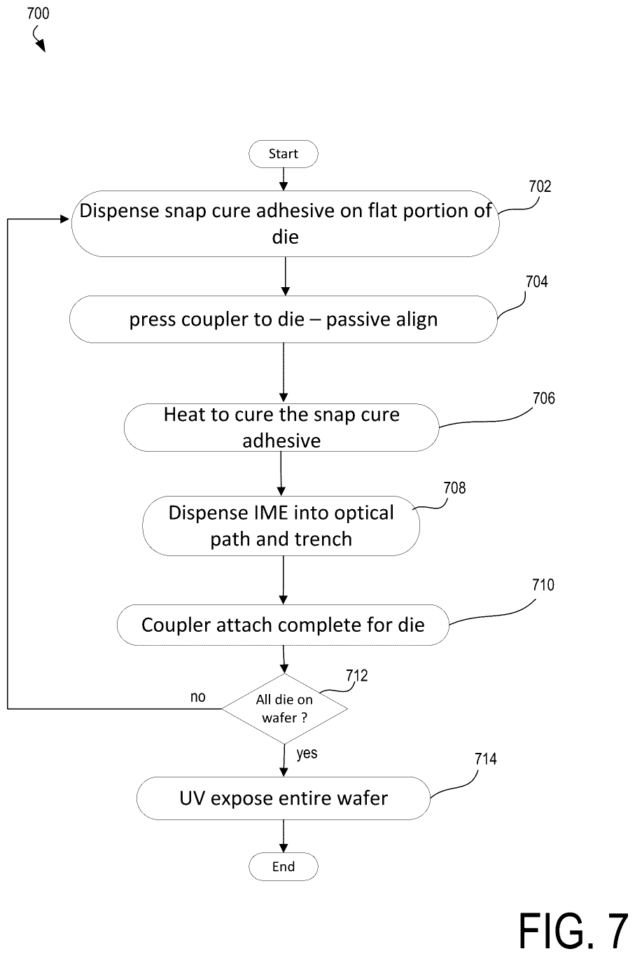

FIGS. 3A, 3B, 3C, 4A, and 4B are simplified top-down views showing a process for implementing an embodiment of the connector architecture implemented in the optical coupler (e.g., embodiment 200), in accordance with various embodiments. FIGS. 5A, 5B, 5C, 6A, and 6B are simplified top-down views showing a process for implementing another embodiment of the connector architecture implemented in the PIC die (e.g., embodiment 250), in accordance with various aspects of this disclosure. FIG. 7 is an exemplary method 700 for manufacturing a photonic integrated circuit (PIC) die attached to an optical connector component that reflects the tasks and operations described in accordance with the FIGS. 3A-6B.

At 702, an adhesive material, such as a snap cure adhesive 304-1 and 304-2 is dispensed on a flat portion of the die comprising the PIC 102/302 (FIG. 3A). This is also reflected in FIG. 5A, with snap cure adhesive 504-1 and 504-2 on PIC 502. At 704, the coupler component 104/304/504 is pressed onto the PIC 102/302/502 die in a passive alignment process, using the v-groove features on respective components, as described above.

At 706, the snap cure adhesive is cured. In an embodiment, it is cured with heat. In another embodiment, it is cured with UV light. The pattern of the snap cure adhesive 372-1 and 372-2 is changed in FIG. 3C (and FIG. 5C) to show a compositional change that the cure process has caused. In FIG. 3B, the coupler component 304 has the TGV embodiment of the connector architecture that includes a TGV (322-1 and 322-2). In FIG. 5B, the coupler component 504 has the embodiment of the connector architecture that includes a cavity comprising a channel and a reservoir (252-1 and 252-2). The cavities or channels extend outward from respective edges of the trench or edge cavity, as illustrated.

At 708 the index matching epoxy (IME) is dispensed into the optical path and trench 109 at the hard gap 108 in front of the optical facet. The IME is dispensed through the TGVs in the embodiment 400 of FIG. 4A; the IME is dispensed into the hard gap in embodiment 600 of FIG. 6A. FIG. 4B and FIG. 6B show the trench 109 filled with the IME. In FIG. 6B, the cavity (e.g., the channel and reservoir features 252-1/252-2) are also filled with IME, as they have accepted any underflow IME.

At 710, the optical connector 104 “attach” to die is complete. In some embodiments, completion can be achieved at 30 seconds per die or unit. This architecture and methodology are remarkably fast compared to available solutions that take about 90 seconds per die or unit to complete the “attach.”

At 712, the method 700 determines whether there are any remaining units or die on the wafer that have not had a coupling component attached thereto yet, and the process returns to 702 until all of the units or die have been completed. In some cases, there may be about 150 die or units per wafer. If all die on the wafer have been completed (i.e., all PIC 102 die have had a respective optical connector 104 component attached) at 712, the process moves to UV exposing the entire wafer at 714.

In various embodiments, at 714, the duration of time for the UV exposure can be about 60 seconds per wafer. Accordingly, the provided architectures and methods can deliver a throughput time of (30 seconds×150 units)+60 seconds=76 minutes per wafer. This is a tremendous advantage, about a 3× improvement over methodologies that take around 225 minutes per wafer.

Thus, architectures and methods for attaching photonic integrated circuits (PICs) to optical connectors have been described. Aspects of the disclosure are characterized by (1) a cavity with a specific peripheral location with respect to a trench at the optical facet of the PIC die, (2) use of a snap cure adhesive as well as IME, and (3) IME in the trench and in the cavity. As mentioned, embodiments can significantly improve the throughput time (TPT) per wafer; in some scenarios, the TPT improvement was 3 times faster than without the methodology and architecture.

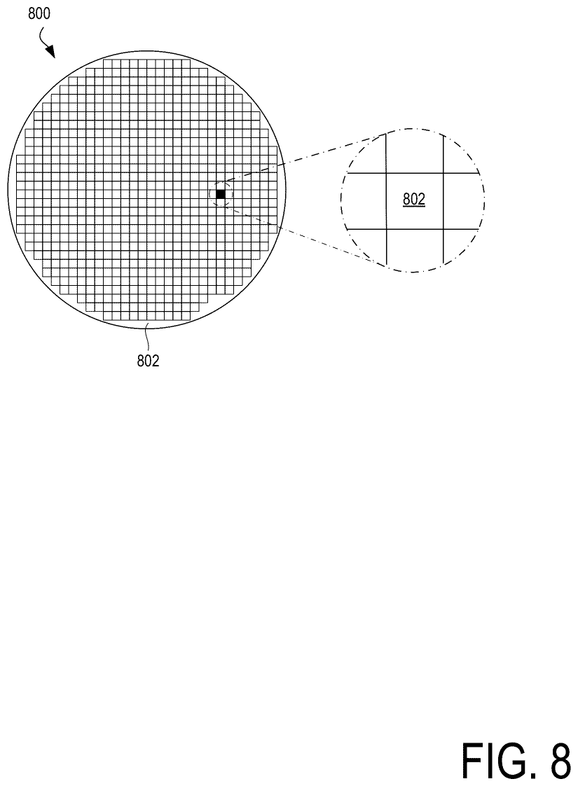

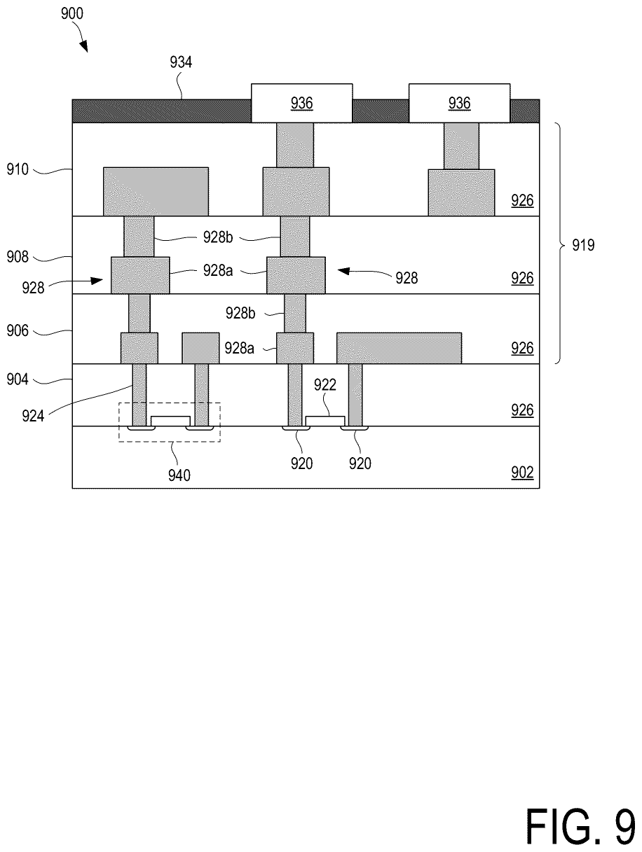

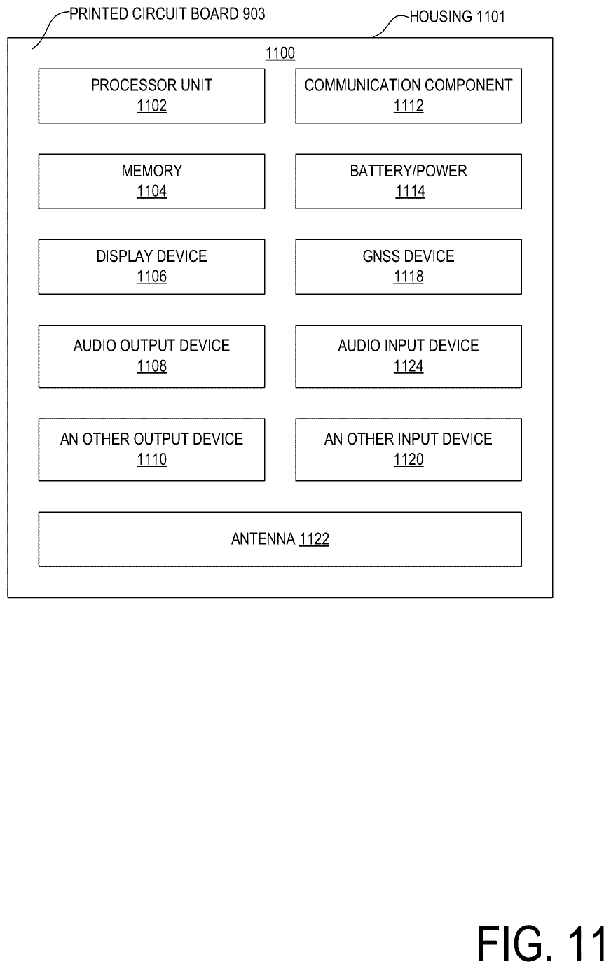

FIG. 8 is a top view of a wafer 800 and dies 802 that may be included in any of the embodiments disclosed herein. The wafer 800 may be composed of semiconductor material and may include one or more dies 802 formed on a surface of the wafer 800. After the fabrication of the integrated circuit components on the wafer 800 is complete, the wafer 800 may undergo a singulation process in which the dies 802 are separated from one another to provide discrete “chips” or destined for a packaged integrated circuit component. The individual dies 802, comprising an integrated circuit component, may include one or more transistors (e.g., some of the transistors 940 of FIG. 9, discussed below), supporting circuitry to route electrical signals to the transistors, passive components (e.g., signal traces, resistors, capacitors, or inductors), and/or any other integrated circuit components. In some embodiments, the wafer 800 or the die 802 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Additionally, multiple devices may be combined on a single die 802. For example, a memory array formed by multiple memory devices may be formed on a same die 802 as a processor unit (e.g., the processor unit 1102 of FIG. 11) or other logic that is configured to store information in the memory devices or execute instructions stored in the memory array. In some embodiments, a die 802 may be attached to a wafer 800 that includes other die, and the wafer 800 is subsequently singulated or diced, this manufacturing procedure is referred to as a die-to-wafer assembly technique.

FIG. 9 is a cross-sectional side view of an integrated circuit 900 that may be included in any of the embodiments disclosed herein. One or more of the integrated circuits 900 may be included in one or more dies 802 (FIG. 8). The integrated circuit 900 may be formed on a die substrate 902 (e.g., the wafer 800 of FIG. 8) and may be included in a die (e.g., the die 802 of FIG. 8).

The die substrate 902 may be a semiconductor substrate composed of semiconductor material systems including, for example, n-type transistors or material or p-type transistors or material systems (or a combination of both). The die substrate 902 may include, for example, a crystalline substrate formed using a bulk silicon or a silicon-on-insulator (SOI) substructure. In some embodiments, the die substrate 902 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 902. Although a few examples of materials from which the die substrate 902 may be formed are described here, any material that may serve as a foundation for an integrated circuit 900 may be used. The die substrate 902 may be part of a singulated die (e.g., the dies 802 of FIG. 8) or a wafer (e.g., the wafer 800 of FIG. 8).

The integrated circuit 900 may include one or more device layers 904 disposed on the die substrate 902. The device layer 904 may include features of one or more transistors 940 (e.g., complementary metal oxide semiconductor field-effect transistors (MOSFETs)) formed on the die substrate 902. The transistors 940 may include, for example, one or more source and/or drain (S/D) regions 920, a gate 922 to control current flow between the S/D regions 920, and one or more S/D contacts 924 to route electrical signals to/from the S/D regions 920.

The gate 922 may be formed of at least two layers, a gate dielectric, and a gate electrode. The gate dielectric may include one layer or a stack of layers. The one or more layers may include silicon oxide, silicon dioxide, silicon carbide, and/or a high-k dielectric material. The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be conducted on the gate dielectric to improve its quality when a high-k material is used.

The gate electrode may be formed on the gate dielectric and may include at least one p-type work function metal or n-type work function metal, depending on whether the transistor 940 is to be a p-type metal oxide semiconductor (PMOS) or an n-type metal oxide semiconductor (NMOS) transistor. In some implementations, the gate electrode may comprise a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 940 along the source-channel-drain direction, the gate electrode may comprise a U-shaped structure that includes a bottom portion substantially parallel to the surface of the die substrate 902 and two sidewall portions that are substantially perpendicular to the top surface of the die substrate 902. In other embodiments, at least one of the metal layers that form the gate electrode may simply be a planar layer that is substantially parallel to the top surface of the die substrate 902 and does not include sidewall portions substantially perpendicular to the top surface of the die substrate 902. In other embodiments, the gate electrode may comprise a combination of U-shaped structures and planar, non-U-shaped structures. For example, the gate electrode may comprise one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and include deposition and etching process steps. In some embodiments, a plurality of spacer pairs may be used; for instance, two pairs, three pairs, or four pairs of sidewall spacers may be formed on opposing sides of the gate stack.

The S/D regions 920 may be formed within the die substrate 902 adjacent to the gate 922 of individual transistors 940. The S/D regions 920 may be formed using an implantation/diffusion process or an etching/deposition process, for example. In the former process, dopants such as boron, aluminum, antimony, phosphorous, or arsenic may be ion-implanted into the die substrate 902 to form the S/D regions 920. An annealing process that activates the dopants and causes them to diffuse farther into the die substrate 902 may follow the ion-implantation process. In the latter process, the die substrate 902 may first be etched to form recesses at the locations of the S/D regions 920. An epitaxial deposition process may then be conducted to fill the recesses with material that is used to fabricate the S/D regions 920. In some implementations, the S/D regions 920 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 920 may be formed using one or more alternate semiconductor materials such as germanium or a group III-V material or alloy. In further embodiments, one or more layers of metal and/or metal alloys may be used to form the S/D regions 920.

Electrical signals, such as power and/or input/output (I/O) signals, may be routed to and/or from the devices (e.g., transistors 940) of the device layer 904 through one or more interconnect layers disposed on the device layer 904 (illustrated in FIG. 9 as interconnect layers 906-910). For example, electrically conductive features of the device layer 904 (e.g., the gate 922 and the S/D contacts 924) may be electrically coupled with the interconnect structures 928 of the interconnect layers 906-910. The one or more interconnect layers 906-910 may form a metallization stack (also referred to as an “ILD stack”) 919 of the integrated circuit 900.

The interconnect structures 928 may be arranged within the interconnect layers 906-910 to route electrical signals according to a wide variety of designs; in particular, the arrangement is not limited to the particular configuration of interconnect structures 928 depicted in FIG. 9. Although a particular number of interconnect layers 906-910 is depicted in FIG. 9, embodiments of the present disclosure include integrated circuits having more or fewer interconnect layers than depicted.

In some embodiments, the interconnect structures 928 may include lines 928a and/or vias 928b filled with an electrically conductive material such as a metal. The lines 928a may be arranged to route electrical signals in a direction of a plane that is substantially parallel with a surface of the die substrate 902 upon which the device layer 904 is formed. For example, the lines 928a may route electrical signals in a direction in and out of the page and/or in a direction across the page. The vias 928b may be arranged to route electrical signals in a direction of a plane that is substantially perpendicular to the surface of the die substrate 902 upon which the device layer 904 is formed. In some embodiments, the vias 928b may electrically couple lines 928a of different interconnect layers 906-910 together.

The interconnect layers 906-910 may include a dielectric material 926 disposed between the interconnect structures 928, as shown in FIG. 9. In some embodiments, dielectric material 926 disposed between the interconnect structures 928 in different ones of the interconnect layers 906-910 may have different compositions; in other embodiments, the composition of the dielectric material 926 between different interconnect layers 906-910 may be the same. The device layer 904 may include a dielectric material 926 disposed between the transistors 940 and a bottom layer of the metallization stack as well. The dielectric material 926 included in the device layer 904 may have a different composition than the dielectric material 926 included in the interconnect layers 906-910; in other embodiments, the composition of the dielectric material 926 in the device layer 904 may be the same as a dielectric material 926 included in any one of the interconnect layers 906-910.

A first interconnect layer 906 (referred to as Metal 1 or “M1”) may be formed directly on the device layer 904. In some embodiments, the first interconnect layer 906 may include lines 928a and/or vias 928b, as shown. The lines 928a of the first interconnect layer 906 may be coupled with contacts (e.g., the S/D contacts 924) of the device layer 904. The vias 928b of the first interconnect layer 906 may be coupled with the lines 928a of a second interconnect layer 908.

The second interconnect layer 908 (referred to as Metal 2 or “M2”) may be formed directly on the first interconnect layer 906. In some embodiments, the second interconnect layer 908 may include via 928b to couple the lines 928a/b of the second interconnect layer 908 with the lines 928a of a third interconnect layer 910. Although the lines 928a and the vias 928b are structurally delineated with a line within individual interconnect layers for the sake of clarity, the lines 928a and the vias 928b may be structurally and/or materially contiguous (e.g., simultaneously filled during a dual-damascene process) in some embodiments.

The third interconnect layer 910 (referred to as Metal 3 or “M3”) (and additional interconnect layers, as desired) may be formed in succession on the second interconnect layer 908 according to similar techniques and configurations described in connection with the second interconnect layer 908 or the first interconnect layer 906. In some embodiments, the interconnect layers that are “higher up” in the metallization stack 919 in the integrated circuit 900 (i.e., farther away from the device layer 904) may be thicker that the interconnect layers that are lower in the metallization stack 919, with lines 928a and vias 928b in the higher interconnect layers being thicker than those in the lower interconnect layers.

The integrated circuit 900 may include a solder resist material 934 (e.g., polyimide or similar material) and one or more conductive contacts 936 formed on the interconnect layers 906-910. In FIG. 9, the conductive contacts 936 are illustrated as taking the form of bond pads. The conductive contacts 936 may be electrically coupled with the interconnect structures 928 and configured to route the electrical signals of the transistor(s) 940 to external devices. For example, solder bonds may be formed on the one or more conductive contacts 936 to mechanically and/or electrically couple an integrated circuit die including the integrated circuit 900 with another component (e.g., a printed circuit board). The integrated circuit 900 may include additional or alternate structures to route the electrical signals from the interconnect layers 906-910; for example, the conductive contacts 936 may include other analogous features (e.g., posts) that route the electrical signals to external components.

In some embodiments in which the integrated circuit 900 is a double-sided die, the integrated circuit 900 may include another metallization stack (not shown) on the opposite side of the device layer(s) 904. This metallization stack may include multiple interconnect layers as discussed above with reference to the interconnect layers 906-910, to provide electrically conductive paths (e.g., including conductive lines and vias) between the device layer(s) 904 and additional conductive contacts (not shown) on the opposite side of the integrated circuit 900 from the conductive contacts 936.

In other embodiments in which the integrated circuit 900 is a double-sided die, the integrated circuit 900 may include one or more through-silicon vias (TSVs) through the die substrate 902; these TSVs may make contact with the device layer(s) 904, and may provide electrically conductive paths between the device layer(s) 904 and additional conductive contacts (not shown) on the opposite side of the integrated circuit 900 from the conductive contacts 936. In some embodiments, TSVs extending through the substrate can be used for routing power and ground signals from conductive contacts on the opposite side of the integrated circuit 900 from the conductive contacts 936 to the transistors 940 and any other components integrated into the die of the integrated circuit 900, and the metallization stack 919 can be used to route I/O signals from the conductive contacts 936 to transistors 940 and any other components integrated into the die of the integrated circuit 900.

Multiple integrated circuits 900 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

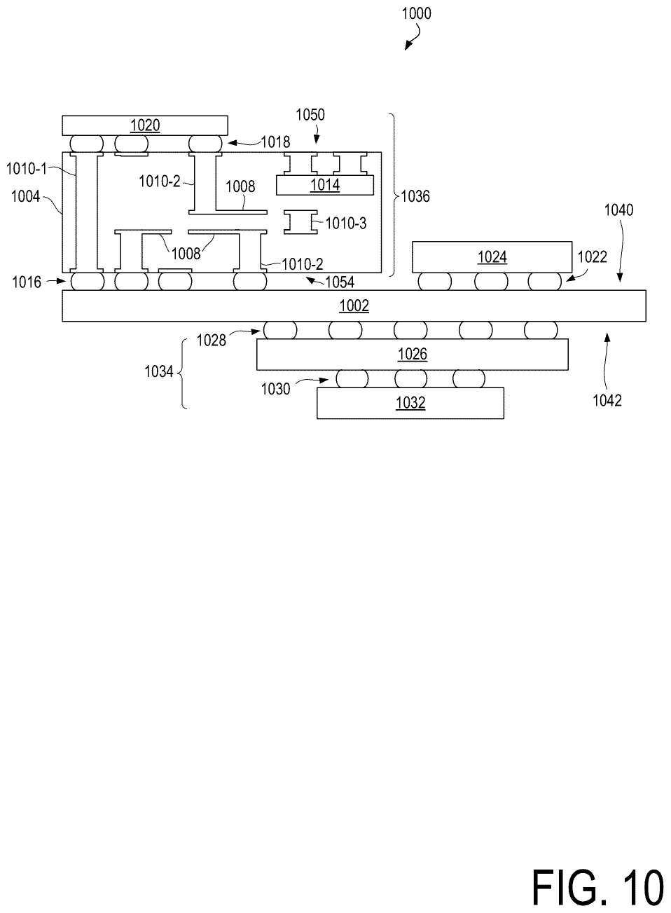

FIG. 10 is a cross-sectional side view of a microelectronic assembly 1000 that may include any of the embodiments disclosed herein. The microelectronic assembly 1000 includes multiple integrated circuit components disposed on a circuit board 1002 (which may be a motherboard, system board, mainboard, etc.). The microelectronic assembly 1000 may include components disposed on a first face 1040 of the circuit board 1002 and an opposing second face 1042 of the circuit board 1002; generally, components may be disposed on one or both faces 1040 and 1042.

In some embodiments, the circuit board 1002 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1002. In other embodiments, the circuit board 1002 may be a non-PCB substrate. The microelectronic assembly 1000 illustrated in FIG. 10 includes a package-on-interposer structure 1036 coupled to the first face 1040 of the circuit board 1002 by coupling components 1016. The coupling components 1016 may electrically and mechanically couple the package-on-interposer structure 1036 to the circuit board 1002, and may include solder balls (as shown in FIG. 10), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 1036 may include an integrated circuit component 1020 coupled to an interposer 1004 by coupling components 1018. The coupling components 1018 may take any suitable form for the application, such as the forms discussed above with reference to the coupling components 1016. Although a single integrated circuit component 1020 is shown in FIG. 10, multiple integrated circuit components may be coupled to the interposer 1004; indeed, additional interposers may be coupled to the interposer 1004. The interposer 1004 may provide an intervening substrate used to bridge the circuit board 1002 and the integrated circuit component 1020.

The integrated circuit component 1020 may be a packaged or unpackaged integrated circuit component that includes one or more integrated circuit dies (e.g., the die 802 of FIG. 8, the integrated circuit 900 of FIG. 9) and/or one or more other suitable components.

The unpackaged integrated circuit component 1020 comprises solder bumps attached to contacts on the die. The solder bumps allow the die to be directly attached to the interposer 1004. In embodiments where the integrated circuit component 1020 comprises multiple integrated circuit die, the die can be of the same type (a homogeneous multi-die integrated circuit component) or of two or more different types (a heterogeneous multi-die integrated circuit component). In addition to comprising one or more processor units, the integrated circuit component 1020 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate, or combinations thereof. A packaged multi-die integrated circuit component can be referred to as a multi-chip package (MCP) or multi-chip module (MCM).

The interposer 1004 may spread connections to a wider pitch or reroute a connection to a different connection. For example, the interposer 1004 may couple the integrated circuit component 1020 to a set of ball grid array (BGA) conductive contacts of the coupling components 1016 for coupling to the circuit board 1002. In the embodiment illustrated in FIG. 10, the integrated circuit component 1020 and the circuit board 1002 are attached to opposing sides of the interposer 1004; in other embodiments, the integrated circuit component 1020 and the circuit board 1002 may be attached to a same side of the interposer 1004. In some embodiments, three or more components may be interconnected by way of the interposer 1004.

In some embodiments, the interposer 1004 may be formed as a PCB, including multiple metal layers separated from one another by layers of dielectric material and interconnected by electrically conductive vias. In some embodiments, the interposer 1004 may be formed of an epoxy resin, a fiberglass-reinforced epoxy resin, an epoxy resin with inorganic fillers, a ceramic material, or a polymer material such as polyimide. In some embodiments, the interposer 1004 may be formed of alternate rigid or flexible materials that may include the same materials described above for use in a semiconductor substrate, such as silicon, germanium, and other group III-V and group IV materials. The interposer 1004 may include metal interconnects 1008 and vias 1010, including but not limited to through hole vias 1010-1 (that extend from a first face 1050 of the interposer 1004 to a second face 1054 of the interposer 1004), blind vias 1010-2 (that extend from the first or second faces 1050 or 1054 of the interposer 1004 to an internal metal layer), and buried vias 1010-3 (that connect internal metal layers).

In some embodiments, the interposer 1004 can comprise a silicon interposer. Through-silicon vias (TSV) extending through the silicon interposer can connect connections on the first face of a silicon interposer to an opposing second face of the silicon interposer. In some embodiments, an interposer 1004 comprising a silicon interposer can further comprise one or more routing layers to route connections on a first face of the interposer 1004 to an opposing second face of the interposer 1004.

The interposer 1004 may further include embedded devices 1014, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1004. The package-on-interposer structure 1036 may take the form of any of the package-on-interposer structures known in the art.

The integrated circuit assembly 1000 may include an integrated circuit component 1024 coupled to the first face 1040 of the circuit board 1002 by coupling components 1022. The coupling components 1022 may take the form of any of the embodiments discussed above with reference to the coupling components 1016, and the integrated circuit component 1024 may take the form of any of the embodiments discussed above with reference to the integrated circuit component 1020.

The integrated circuit assembly 1000 illustrated in FIG. 10 includes a package-on-package structure 1034 coupled to the second face 1042 of the circuit board 1002 by coupling components 1028. The package-on-package structure 1034 may include an integrated circuit component 1026 and an integrated circuit component 1032 coupled together by coupling components 1030 such that the integrated circuit component 1026 is disposed between the circuit board 1002 and the integrated circuit component 1032. The coupling components 1028 and 1030 may take the form of any of the embodiments of the coupling components 1016 discussed above, and the integrated circuit components 1026 and 1032 may take the form of any of the embodiments of the integrated circuit component 1020 discussed above. The package-on-package structure 1034 may be configured in accordance with any of the package-on-package structures known in the art.

FIG. 11 is a block diagram of an example electrical device 1100 that may include one or more of the embodiments disclosed herein. For example, any suitable ones of the components of the electrical device 1100 may include one or more of the disclosed embodiments, semiconductor assemblies, package assemblies, microelectronic assemblies 1000, integrated circuit components 1020, integrated circuits 900, integrated circuit dies 802, or structures disclosed herein, attached on a printed circuit board 1101. A number of components are illustrated in FIG. 11 as included in the electrical device 1100, but any one or more of these components may be omitted or duplicated, as suitable for the application. In some embodiments, some or all the components included in the electrical device 1100 may be attached to one or more motherboards, mainboards, printed circuit boards, or system boards. In some embodiments, one or more of these components are fabricated onto a single system-on-a-chip (SoC) die. In various embodiments, the electrical device 1100 is enclosed by, or integrated with, a housing 1103.

Additionally, in various embodiments, the electrical device 1100 may not include one or more of the components illustrated in FIG. 11, but the electrical device 1100 may include interface circuitry for coupling to the one or more components. For example, the electrical device 1100 may not include a display device 1106, but may include display device interface circuitry (e.g., a connector and driver circuitry) to which a display device 1106 may be coupled. In another set of examples, the electrical device 1100 may not include an audio input device 1124 or an audio output device 1108, but may include audio input or output device interface circuitry (e.g., connectors and supporting circuitry) to which an audio input device 1124 or audio output device 1108 may be coupled.

The electrical device 1100 may include one or more processor units 1102 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1102 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller crypto processors (specialized processors that execute cryptographic algorithms within hardware), server processors, controllers, or any other suitable type of processor units. As such, the processor unit can be referred to as an XPU (or xPU).

The electrical device 1100 may include a memory 1104, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1104 may include memory that is located on the same integrated circuit die as the processor unit 1102. This memory may be used as cache memory (e.g., Level 1 (L1), Level 2 (L2), Level 3 (L3), Level 4 (L4), Last Level Cache (LLC)) and may include embedded dynamic random-access memory (eDRAM) or spin transfer torque magnetic random-access memory (STT-MRAM).

In some embodiments, the electrical device 1100 can comprise one or more processor units 1102 that are heterogeneous or asymmetric to another processor unit 1102 in the electrical device 1100. There can be a variety of differences between the processor units 1102 in a system in terms of a spectrum of metrics of merit including architectural, microarchitectural, thermal, power consumption characteristics, and the like. These differences can effectively manifest themselves as asymmetry and heterogeneity among the processor units 1102 in the electrical device 1100.

In some embodiments, the electrical device 1100 may include a communication component 1112 (e.g., one or more communication components). For example, the communication component 1112 can manage wireless communications for the transfer of data to and from the electrical device 1100. The term “wireless” and its derivatives may be used to describe circuits, devices, systems, methods, techniques, communications channels, etc., that may communicate data using modulated electromagnetic radiation through a nonsolid medium. The term “wireless” does not imply that the associated devices do not contain any wires, although in some embodiments they might not.

The communication component 1112 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1112 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1112 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1112 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1112 may operate in accordance with other wireless protocols in other embodiments. The electrical device 1100 may include an antenna 1122 to facilitate wireless communications and/or to receive other wireless communications (such as AM or FM radio transmissions).

In some embodiments, the communication component 1112 may manage wired communications, such as electrical, optical, or any other suitable communication protocols (e.g., IEEE 802.3 Ethernet standards). As noted above, the communication component 1112 may include multiple communication components. For instance, a first communication component 1112 may be dedicated to shorter-range wireless communications such as Wi-Fi or Bluetooth, and a second communication component 1112 may be dedicated to longer-range wireless communications such as global positioning system (GPS), EDGE, GPRS, CDMA, WiMAX, LTE, EV-DO, or others. In some embodiments, a first communication component 1112 may be dedicated to wireless communications, and a second communication component 1112 may be dedicated to wired communications.

The electrical device 1100 may include power supply such as a battery/power circuitry 1114. The battery/power circuitry 1114 may include one or more energy storage devices (e.g., batteries or capacitors) and/or circuitry for coupling components of the electrical device 1100 to an energy source separate from the electrical device 1100 (e.g., AC line power).

The electrical device 1100 may include a display device 1106 (or corresponding interface circuitry, as discussed above). The display device 1106 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1100 may include an audio output device 1108 (or corresponding interface circuitry, as discussed above). The audio output device 1108 may include any embedded or wired or wirelessly connected external device that generates an audible indicator, such speakers, headsets, or earbuds.

The electrical device 1100 may include an audio input device 1124 (or corresponding interface circuitry, as discussed above). The audio input device 1124 may include any embedded or wired or wirelessly connected device that generates a signal representative of a sound, such as microphones, microphone arrays, or digital instruments (e.g., instruments having a musical instrument digital interface (MIDI) output). The electrical device 1100 may include a Global Navigation Satellite System (GNSS) device 1118 (or corresponding interface circuitry, as discussed above), such as a Global Positioning System (GPS) device. The GNSS device 1118 may be in communication with a satellite-based system and may determine a geolocation of the electrical device 1100 based on information received from one or more GNSS satellites, as known in the art.

The electrical device 1100 may include another output device 1110 (or corresponding interface circuitry, as discussed above). Examples of the other output device 1110 may include an audio codec, a video codec, a printer, a wired or wireless transmitter for providing information to other devices, or an additional storage device.

The electrical device 1100 may include another input device 1120 (or corresponding interface circuitry, as discussed above). Examples of the other input device 1120 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1100 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra-mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1100 may be any other electronic device that processes data. In some embodiments, the electrical device 1100 may comprise multiple discrete physical components. Given the range of devices that the electrical device 1100 can be manifested as in various embodiments, in some embodiments, the electrical device 1100 can be referred to as a computing device or a computing system.

While at least one embodiment has been presented in the foregoing detailed description, it should be appreciated that a vast number of variations exist. It should also be appreciated that the disclosed embodiments are only examples, and are not intended to limit the scope, applicability, or configuration of the disclosure in any way. Rather, the foregoing detailed description will provide those skilled in the art with a convenient road map for implementing the disclosed embodiment embodiments. Various changes can be made in the function and arrangement of elements without departing from the scope of the disclosure as set forth in the appended claims and the legal equivalents thereof.

As used herein, the term “adjacent” refers to layers or components that are in direct physical contact with each other, with no layers or components in between them. For example, a layer X that is adjacent to a layer Y refers to a layer that is in direct physical contact with layer Y. In contrast, as used herein, the phrase(s) “located on” (in the alternative, “located under,” “located above/over,” or “located next to,” in the context of a first layer or component located on a second layer or component) includes (i) configurations in which the first layer or component is directly physically attached to the second layer (i.e., adjacent), and (ii) component and configurations in which the first layer or component is attached (e.g. coupled) to the second layer or component via one or more intervening layers or components.

Terms or values modified by the word “substantially” include arrangements, orientations, spacings, or positions that vary plus or minus 20% from the meaning of the unmodified term or value. Terms or values modified by the word “about” include values inclusive of 10% less than the term or value to inclusive of 10% greater than the term or value.

As used herein, the term “electronic component” can refer to an active electronic circuit (e.g., processing unit, memory, storage device, FET) or a passive electronic circuit (e.g., resistor, inductor, capacitor).

As used herein, the term “integrated circuit component” can refer to an electronic component configured on a semiconducting material to perform a function. An integrated circuit (IC) component can comprise one or more of any computing system components described or referenced herein or any other computing system component, such as a processor unit (e.g., system-on-a-chip (SoC), processor core, graphics processor unit (GPU), accelerator, chipset processor), I/O controller, memory, or network interface controller, and can comprise one or more additional active or passive devices such as capacitors, decoupling capacitors, resistors, inductors, fuses, diodes, transformers, sensors, electrostatic discharge (ESD) devices, and memory devices.

A non-limiting example of an unpackaged integrated circuit component includes a single monolithic integrated circuit die (also shortened herein to “die”); the die may include solder bumps attached to contacts on the die. When present on the die, the solder bumps or other conductive contacts can enable the die to be directly attached to a printed circuit board (PCB) or other substrates.

A non-limiting example of a packaged integrated circuit component comprises one or more integrated circuit dies mounted on a package substrate with the integrated circuit dies and package substrate encapsulated in a casing material, such as a metal, plastic, glass, or ceramic. Often the casing includes an integrated heat spreader (IHS); the packaged integrated circuit component often has bumps, leads, or pins attached to the package substrate (either directly or by wires attaching the bumps, leads, or pins to the package substrate) for attaching the packaged integrated circuit component to a printed circuit board (or motherboard or base board) or another component.

As used herein, phrases such as “an embodiment,” “various embodiments,” “some embodiments,” and the like, indicate that some embodiments may have some, all, or none of the features described for other embodiments. “First,” “second,” “third,” and the like describe a common object and indicate different instances of like objects being referred to; unless specifically stated, they do not imply a given sequence, either temporally or spatially, in ranking, or any other manner. In accordance with patent application parlance, “connected” indicates elements that are in direct physical or electrical contact with each other and “coupled” indicates elements that co-operate or interact with each other, coupled elements may or may not be in direct physical or electrical contact. Furthermore, the terms “comprising,” “including,” “having,” and the like, are utilized synonymously to denote non-exclusive inclusions.

As used in this application and the claims, a list of items joined by the term “at least one of” or the term “one or more of” can mean any combination of the listed terms. For example, the phrase “at least one of A, B or C” can mean A; B; C; A and B; A and C; B and C; or A, B, and C. Likewise, the phrase “one or more of A, B and C” can mean A; B; C; A and B; A and C; B and C; or A, B, and C.

As used in this application and the claims, the phrase “individual of” or “respective of” following by a list of items recited or stated as having a trait, feature, etc. means that all the items in the list possess the stated or recited trait, feature, etc. For example, the phrase “individual of A, B, or C, comprise a sidewall” or “respective of A, B, or C, comprise a sidewall” means that A comprises a sidewall, B comprises sidewall, and C comprises a sidewall.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following examples pertain to additional embodiments of technologies disclosed herein.

### Examples

Example 1 is an apparatus, comprising: a semiconductor substrate including a photonic integrated circuit (PIC), the PIC including an optical facet and waveguides that terminate at the optical facet; an optical connector component optically coupled to the waveguides of the PIC via the optical facet, forming a gap therebetween; an index matching epoxy (IME) in the gap between the optical facet and the optical connector component; and a cavity in the semiconductor substrate or in the optical connector component, wherein the IME in the gap is in fluid communication with the cavity.

Example 2 includes the subject matter of Example 1, wherein the cavity is a through glass via (TGV) formed in the optical connector component.

Example 3 includes the subject matter of Example 1, wherein the cavity includes a channel formed in the semiconductor substrate.

Example 4 includes the subject matter of Example 3, wherein the cavity further comprises a reservoir in fluid communication with the channel, the reservoir formed in the semiconductor substrate.

Example 5 includes the subject matter of any one of Examples 1-4, further comprising an adhesive material between a surface of the semiconductor substrate and the optical connector component.

Example 6 includes the subject matter of Example 5, wherein the adhesive material is a snap cure adhesive.

Example 7 includes the subject matter of any one of Examples 1-6, further comprising a band of v-grooves formed in a surface of the semiconductor substrate.

Example 8 includes the subject matter of Example 7, further comprising a row of v-grooves formed in the optical connector component.

Example 9 is an apparatus, comprising: a photonic integrated circuit (PIC) die, the PIC die including a trench alongside an optical waveguide facet; a channel formed in the PIC die, the channel extending outward from the trench; and an adhesive material on a surface of the PIC die.

Example 10 includes the subject matter of Example 9, wherein the adhesive material is a snap cure adhesive.

Example 11 includes the subject matter of Example 9, further comprising a band of v-grooves formed in the surface of the PIC die.

Example 12 includes the subject matter of Example 9, further comprising an optical connector component optically coupled to the PIC via the optical waveguide facet.

Example 13 includes the subject matter of Example 12, further comprising index matching epoxy (IME) in the trench between the optical connector component and the optical waveguide facet.

Example 14 includes the subject matter of Example 13, wherein the IME extends into the channel.

Example 15 includes the subject matter of Example 14, further comprising a reservoir in fluid communication with the channel, the reservoir formed in the PIC die.

Example 16 includes the subject matter of Example 15, wherein the IME extends into the reservoir.

Example 17 is a method comprising: fabricating a photonic integrated circuit (PIC) die with a trench alongside an optical facet, and a channel, and wherein the channel extends outward from the trench at a surface of the PIC die.

Example 18 includes the subject matter of Example 17, further comprising dispensing a snap cure adhesive on the surface of the PIC die.

Example 19 includes the subject matter of Example 18, further comprising: placing an optical connector component on the PIC die over the snap cure adhesive, thereby creating a gap over the trench and between the PIC die and the optical connector component; curing the snap cure adhesive with heat; and dispensing index matching adhesive (IME) in the gap.

Example 20 includes the subject matter of Example 19, wherein dispensing IME in the gap includes capillary underflow into the channel.

What is claimed is:

1. An apparatus, comprising:
a semiconductor substrate including a photonic integrated circuit (PIC), the PIC including an optical facet and waveguides that terminate at the optical facet;
an optical connector component optically coupled to the waveguides of the PIC via the optical facet, forming a gap therebetween;
an index matching epoxy (IME) in the gap between the optical facet and the optical connector component; and
a cavity in the semiconductor substrate or in the optical connector component, wherein the IME in the gap is in fluid communication with the cavity.

2. The apparatus of claim 1, wherein the cavity is a through glass via (TGV) formed in the optical connector component.

3. The apparatus of claim 1, wherein the cavity includes a channel formed in the semiconductor substrate.

4. The apparatus of claim 3, wherein the cavity further comprises a reservoir in fluid communication with the channel, the reservoir formed in the semiconductor substrate.

5. The apparatus of claim 1, further comprising an adhesive material between a surface of the semiconductor substrate and the optical connector component.

6. The apparatus of claim 5, wherein the adhesive material is a snap cure adhesive.

7. The apparatus of claim 1, further comprising a band of v-grooves formed in a surface of the semiconductor substrate.

8. The apparatus of claim 7, further comprising a row of v-grooves formed in the optical connector component.

9. An apparatus, comprising:
a photonic integrated circuit (PIC) die, the PIC die including a trench alongside an optical waveguide facet;
a channel formed in the PIC die, the channel extending outward from the trench; and
an adhesive material on a surface of the PIC die.

10. The apparatus of claim 9, wherein the adhesive material is a snap cure adhesive.

11. The apparatus of claim 9, further comprising a band of v-grooves formed in the surface of the PIC die.

12. The apparatus of claim 9, further comprising an optical connector component optically coupled to the PIC via the optical waveguide facet.

13. The apparatus of claim 12, further comprising index matching epoxy (IME) in the trench between the optical connector component and the optical waveguide facet.

14. The apparatus of claim 13, wherein the IME extends into the channel.

15. The apparatus of claim 14, further comprising a reservoir in fluid communication with the channel, the reservoir formed in the PIC die.

16. The apparatus of claim 15, wherein the IME extends into the reservoir.

17. A method comprising:
fabricating a photonic integrated circuit (PIC) die with a trench alongside an optical facet, and a channel, and wherein the channel extends outward from the trench at a surface of the PIC die.

18. The method of claim 17, further comprising dispensing a snap cure adhesive on the surface of the PIC die.

19. The method of claim 18, further comprising:
placing an optical connector component on the PIC die over the snap cure adhesive, thereby creating a gap over the trench and between the PIC die and the optical connector component;
curing the snap cure adhesive; and
dispensing index matching adhesive (IME) in the gap.

20. The method of claim 19, wherein dispensing IME in the gap includes capillary underflow into the channel.
